(19) United States
(12) Patent Application Publication
(10) Pub. No.: US 2024/0394073 A1
(43) Pub. Date: Nov. 28, 2024

(54) DYNAMIC ACCESSIBILITY-BASED GRAPHICAL USER INTERFACE FOR EDUCATIONAL PLATFORMS

(71) Applicant: Al-Learners, Inc., Brooklyn, NY (US)

(72) Inventor: Adele SMOLANSKY, Brooklyn, NY (US)

(21) Appl. No.: 18/671,777

(22) Filed: May 22, 2024

Related U.S. Application Data
(60) Provisional application No. 63/468,118, filed on May 22, 2023.

(51) Int. Cl. G06F 9/451; G09B 5/02; H04L 67/306

(52) U.S. Cl. CPC G06F 9/451; G09B 5/02; H04L 67/306

(57) ABSTRACT

Disclosed herein are systems and method for updating a graphical user interface (GUI) of an educational platform. A method includes: identifying a first accessibility indicator in a user profile of a user accessing the educational platform, wherein the educational platform includes a plurality of activity modules that test educational knowledge; generating, for display on a computing device, the GUI in a first layout suitable for students with the first accessibility indicator; monitoring an interaction of the user with the GUI when accessing an activity module of the plurality of activity modules on the GUI; and in response to detecting a second accessibility indicator based on the monitored interaction, updating, for display on the computing device, the GUI to a second layout that is a variation of the first layout, wherein the second layout is suitable for students with both the first accessibility indicator and the second accessibility indicator.

### CROSS-REFERENCE TO RELATED APPLICATIONS

This application claims the benefit of U.S. Provisional Application No. 63/468,118, filed May 22, 2023, which is herein incorporated by reference.

### FIELD OF TECHNOLOGY

The present disclosure relates to the field of graphical user interfaces, and, more specifically, to systems and methods for incrementally updating a graphical user interface of an educational platform to accommodate usage preferences and/or accessibility issues of a user.

### BACKGROUND

Conventional graphical user interfaces (GUIs) have revolutionized how people interact with technology, but when it comes to educational platforms for young students with disabilities, their utility often falls short. These interfaces, designed primarily for mainstream users, struggle to accommodate the diverse needs and abilities of students with disabilities, thereby hindering their learning experience. This failure stems from several factors, including limited accessibility features, lack of customization options, and insufficient consideration of diverse learning styles and needs. As a result, young students with disabilities often encounter barriers that impede their access to educational content and inhibit their ability to fully engage and succeed in learning activities. Addressing these shortcomings requires a reimagining of educational interfaces to prioritize inclusivity, accessibility, and flexibility, ensuring that all students, regardless of their abilities, can access and benefit from educational technology.

### SUMMARY

The ease of use for a GUI is highly important for any software application. Even the most intuitive software application can be severely limited if its GUI is too complex. In the case of educational platforms, especially those directed to children, the layout of the GUI should not hinder the learning experience. After all, children are not only learning the educational material, but are also learning to navigate software and hardware technology. This is amplified when a child has an accessibility issue caused by, for example, a disability. If a child has trouble seeing, speaking, hearing, and/or comprehending, a standard GUI that is geared at a general student audience will be an ineffective teaching tool for the child. Even if a GUI has certain accessibility features, because every child is different and grows rapidly over time, the accessibility features useful at a first point in time may not be required or as useful at a second point in time. To address the shortcomings of conventional GUIs, the systems and methods of the present disclosure describe a dynamic accessibility-based GUI for educational platforms.

In one exemplary aspect, the techniques described herein relate to a method for updating a graphical user interface (GUI) of an educational platform, the method including: identifying a first accessibility indicator in a user profile of a user accessing the educational platform, wherein the educational platform includes a plurality of activity modules that test an educational knowledge of the user; generating, for display on a computing device, the GUI in a first layout suitable for students with the first accessibility indicator; monitoring an interaction of the user with the GUI when accessing an activity module of the plurality of activity modules on the GUI; and in response to detecting a second accessibility indicator based on the monitored interaction, updating, for display on the computing device, the GUI to a second layout that is a variation of the first layout, wherein the second layout is suitable for students with both the first accessibility indicator and the second accessibility indicator.

In some aspects, the techniques described herein relate to a method, further including: monitoring another interaction of the user with the GUI when accessing another activity module of the plurality of activity modules on the GUI; and in response to detecting a third accessibility indicator based on the another interaction, updating, for display on the computing device, the GUI to a third layout that is a variation of the second layout, wherein the third layout is suitable for students with the first accessibility indicator, the second accessibility indicator, and the third accessibility indicator.

In some aspects, the techniques described herein relate to a method, further including: monitoring another interaction of the user with the GUI when accessing another activity module of the plurality of activity modules on the GUI; and in response to determining that the another interaction does not include the second accessibility indicator, reverting the GUI to the first layout.

In some aspects, the techniques described herein relate to a method, wherein monitoring the interaction includes determining one or more of: (1) an amount of time taken to fully complete the activity module, (2) an amount of time taken to complete a portion of the activity module, (3) a number of times the activity module is closed or restarted, (4) an amount of times a portion of the activity module is restarted, (5) a number of correct responses received from the user in the activity module, (6) a number of incorrect responses received from the user in the activity module, (7) an amount of manual setting adjustments made during the activity module, (8) user selections, (9) an amount of attempts taken by the user to complete the activity module, and (10) and amount of supports taken by the user to complete the activity module.

In some aspects, the techniques described herein relate to a method, wherein detecting the second accessibility indicator based on the monitored interaction includes executing a machine learning algorithm trained to detect accessibility indicators based on activity scores and clickstream data and from one or more of the plurality of activity modules.

In some aspects, the techniques described herein relate to a method, wherein updating the GUI to the second layout includes executing a machine learning algorithm that utilizes reinforcement learning to optimize the GUI for the user such that an amount of time to complete the activity module is minimized and an amount of correct responses received from the user in the activity module is maximized.

In some aspects, the techniques described herein relate to a method, wherein the first accessibility indicator is a disability at a first severity level and the second accessibility indicator is the disability at a second severity level.

In some aspects, the techniques described herein relate to a method, wherein the GUI includes a plurality of virtual objects, and wherein updating the GUI to the second layout includes incrementally altering one or more of: (1) a type of virtual object depicted on the GUI, (2) a size of a virtual object depicted on the GUI, (3) a virtual distance between two or more virtual objects, (4) a color of the virtual object, and (5) a sound associated with selecting the virtual object.

In some aspects, the techniques described herein relate to a method, wherein the first accessibility indicator includes one of a behavioral disability, vision impairment, a hearing impairment, a cognitive impairment, a mental disorder, motor impairment.

In some aspects, the techniques described herein relate to a method, wherein the user profile is indicative of one or more of: an age, a gender, a school grade level, scores on any of the plurality of activity modules, and any known accessibility issues.

It should be noted that the methods described above may be implemented in a system comprising a hardware processor. Alternatively, the methods may be implemented using computer executable instructions of a non-transitory computer readable medium.

In some aspects, the techniques described herein relate to a system for updating a graphical user interface (GUI) of an educational platform, including: at least one memory; at least one hardware processor coupled with the at least one memory and configured, individually or in combination, to: identify a first accessibility indicator in a user profile of a user accessing the educational platform, wherein the educational platform includes a plurality of activity modules that test an educational knowledge of the user; generate, for display on a computing device, the GUI in a first layout suitable for students with the first accessibility indicator; monitor an interaction of the user with the GUI when accessing an activity module of the plurality of activity modules on the GUI; and in response to detecting a second accessibility indicator based on the monitored interaction, update, for display on the computing device, the GUI to a second layout that is a variation of the first layout, wherein the second layout is suitable for students with both the first accessibility indicator and the second accessibility indicator.

In some aspects, the techniques described herein relate to a non-transitory computer readable medium storing thereon computer executable instructions for updating a graphical user interface (GUI) of an educational platform, including instructions for: identifying a first accessibility indicator in a user profile of a user accessing the educational platform, wherein the educational platform includes a plurality of activity modules that test an educational knowledge of the user; generating, for display on a computing device, the GUI in a first layout suitable for students with the first accessibility indicator; monitoring an interaction of the user with the GUI when accessing an activity module of the plurality of activity modules on the GUI; and in response to detecting a second accessibility indicator based on the monitored interaction, updating, for display on the computing device, the GUI to a second layout that is a variation of the first layout, wherein the second layout is suitable for students with both the first accessibility indicator and the second accessibility indicator.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for incrementally updating a graphical user interface of an educational platform to accommodate accessibility issues of a user.

FIG. 2 is a first view of the user interface of the educational platform.

FIG. 3 is a second view of the user interface of the educational platform.

FIG. 4 is a third view of the user interface of the educational platform.

FIG. 5 is a fourth view of the user interface of the educational platform.

FIG. 6 is a fifth view of the user interface of the educational platform.

FIG. 7 is a sixth view of the user interface of the educational platform.

FIG. 8a is a seventh view of the user interface of the educational platform.

FIG. 8b is a eighth view of the user interface of the educational platform.

FIG. 9 is a ninth view of the user interface of the educational platform.

FIG. 10 is a diagram of layout updates in the user interface of the educational platform.

FIG. 11 is another diagram of layout updates in the user interface of the educational platform.

FIG. 12 illustrates a flow diagram of a method for incrementally updating a graphical user interface of an educational platform to accommodate accessibility issues of a user.

FIG. 13 presents an example of a general-purpose computer system on which aspects of the present disclosure can be implemented.

### DETAILED DESCRIPTION

Exemplary aspects are described herein in the context of a system, method, and computer program product for incrementally updating a graphical user interface (GUI) of an educational platform to accommodate accessibility issues of a user. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

As mentioned previously, conventional graphical user interfaces (GUIs) provide a “one size fits all” solution for students. However, students with disabilities require personalized and customized learning tools that better support their individual needs. The present disclosure describes an educational platform called AI-Learners, which personalizes learning for students by setting specific GUI layouts (e.g., visual design) and activity modules (e.g., math and reading exercises) based on user preferences (e.g., accessibility needs) of a user. This personalization is a continuous process and the speed at which the GUI changes is customizable. AI-Learners further facilitates customized learning by allowing students and teachers to manually change aspects of activity modules and the GUI. It should be noted that the same activity module taken by a class of students may look different for each student depending on the needs of the student. Ideally, the personalized GUI will make it such that the student can optimize learning the educational material by minimizing obstacles posed by GUI design. AI-Learners is compatible with assistive technology comprising a combination of screen readers, magnifiers, eye gaze, text-to-speech, etc., to accommodate a variety of impairments that may make interacting with a conventional GUI frustrating.

In addition to adjusting the GUI itself, AI-Learners further adjusts the activity modules that a user interacts with. AI-Learners may help students by personalizing the learning rate to each student's cognitive abilities. Other educational platforms may claim to personalize learning rates, but their personalization is based on assumptions that apply to the average student. For example, certain platforms require students to answer a fixed number of math questions before moving onto the next level or topic. This is insufficient for students with learning difficulties (e.g., dyscalculia) because they need extra support and may not reach certain targets as easily as an average student would.

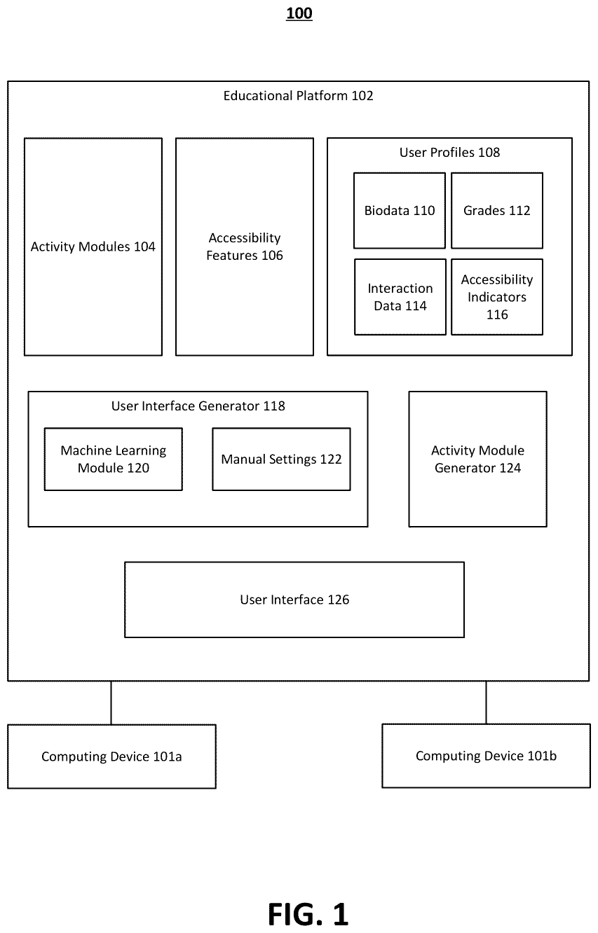

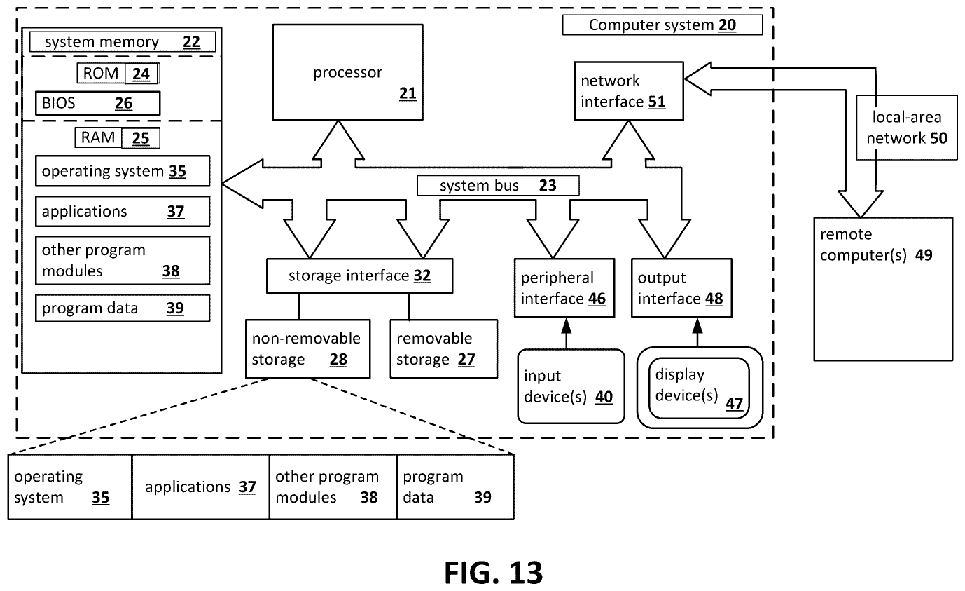

FIG. 1 is a block diagram illustrating system 100 for incrementally updating a graphical user interface of an educational platform to accommodate accessibility issues of a user. System 100 includes one or more computing devices (e.g., computing device 101a, computing device 101b, etc.), each of which execute/store at least one portion of educational platform 102 (e.g., AI-Learners). The structure of a computing device is described in FIG. 13. Educational platform 102 may be a software application or a web application.

In some aspects, each computing device 101 may belong to a student. In some aspects, computing device 101a may belong to a student and computing device 101b may belong to a teacher. In some aspects, computing device 101a may be a device such as a smartphone or a laptop on which a user accesses user interface 126; computing device 101b may be a device such as a server that executes user interface generator 118 and activity module generator 124, and further stores activity modules 104, accessibility features 106, and user profiles 108.

In an exemplary aspect, educational platform 102 enables users to interact with various activity modules 104. Each module represents a game or demonstration that tests the knowledge of the user. For example, an activity module may be a math quiz that tests addition. A user with administrator access (e.g., a teacher) may create or edit activity modules 104 using activity module generator 124 to test a set of learning users (e.g., a class of students). Activity module generator 124 may be a separate portion of user interface 126 that is only accessible to an administrator. Activity module generator 124 may include a test bank from which an administrator can select activities or questions of different difficulties. Certain activity modules may be labeled as catering to a specific audience. For example, there may be certain activity modules associated with training a user's memory that are recommended for users with memory-related disorders.

An activity module may be visually made up of multiple virtual objects. A virtual object may be a text block, a graphic, a video, etc. For example, a first virtual object may be a text block with a question. The question may be a multiple choice question with four answer choices. Each answer choice may be represented as a virtual object (e.g., a graphic of a shape containing an answer choice).

Accessibility features 106 includes a variety of settings that can be adjusted based on the needs of a user. Accessibility features 106 aim to make activity interaction more inclusive for users with disabilities. These features can include options for customizable controls, such as remapping buttons or adjusting sensitivity, to accommodate different physical abilities. Visual accessibility features may include options for adjusting colors, brightness, contrast, font size, font type, spacing between virtual objects, or adding subtitles and captions for users with visual impairments or hearing difficulties. Such features may further incorporate audio cues or visual indicators to assist users with cognitive disabilities or provide alternative modes for completing activities.

There are many other specific accessibility features that are offered by educational platform 102 that may be executed depending on the needs/preferences of a user. For example, user interface generator 118 may (1) implement audio alternatives to all text, (2) provide reinforcement after answering a question (e.g., where the word “correct” or “good job” appears on the screen, math explanations, etc.), (3) visually highlight specific words in text when audio is playing, (4) switch between representations of characters and numbers (e.g., show the number “1,” the word “ONE,” or show one apple), (5) switch between languages (e.g., English, Spanish, French, etc.), (6) provide hints when a user does not know how to respond to a question or navigate the interface (e.g., generate a point icon to motivate the user to select virtual object that the icon is pointing to), (7) use visuals, animations, and sounds while minimizing text, (8) shorten or elongate animations in activity modules, (9) change color configurations of virtual objects to enhance visibility, (10) change graphics to improve comprehension (e.g., replace real-world images such as a photo of an apple to cartoon images such as a color drawing of an apple).

Whether a user needs a particular accessibility feature is determined based on his/her user profile. User profiles 108 is a collection of profiles, each of which include biodata 110, grades 112, interaction data 114, and accessibility indicators 116. Biodata 110 includes personal information (e.g., name, gender, age, grade level, etc.). Grades 112 include scores of a user for each activity module he/she has taken from activity modules 104. Accessibility indicators 116 include preferences for accessibility features and/or known disorders (e.g., a sight-based disorder, a hearing disorder, a speaking disorder, a mental disorder, a physical disability, etc.). For example, accessibility indicators 116 may indicate that the user generally prefers high contrast visuals and/or may list a sight-based disorder that requires high contrast visuals. Interaction data 114 includes clickstream data and/or analyzed clickstream data. For example, interaction data 114 may include the following analysis of clickstream data: (1) an amount of time taken to fully complete an activity module, (2) an amount of time taken to complete a portion (e.g., a question, a mini-game, a reading activity, etc.) of the activity module, (3) an amount of times the activity module is closed or restarted (e.g., due to the user quitting), (4) an amount of times a portion of the activity module is restarted (e.g., due to the user wanting to revisit a question), (5) an amount of correct responses received from the user in the activity module, (6) an amount of time taken to provide each correct response, (7) an amount of incorrect responses received from the user in the activity module, (8) an amount of time taken to provide each incorrect response, and (9) an amount of manual setting adjustments made during the activity module (e.g., manually changing brightness, font size, etc.).

User interface generator 118 is configured to generate user interface 126. In particular, user interface generator 118 creates a layout for an activity module that is accessed by a user. The layout includes accessibility features based on the user profile of the user. When a user logs into educational platform 102 via user interface 126, the specific user profile of the user is retrieved from user profiles 108 (e.g., based on the provided login credentials). User interface generator 118 presents a plurality of activity modules accessible to the user according to the retrieved user profile. For example, the user profile may indicate that the user has a plurality of activity modules assigned to him/her. User interface generator 118 may present the plurality of activity modules on user interface 126. In response to receiving a selection of an activity module, user interface generator 118 may initiate the activity module. It should be noted that the menus and activity modules provided to the user are generated using accessibility features needed/preferred by the user, as indicated by accessibility indicators in the user profile.

In an exemplary aspect, user interface generator 118 may identify a first accessibility indicator in the user profile of the user accessing the educational platform. The first accessibility indicator may be a physical limitation such as a motor impairment, a hearing impairment, a visual impairment, etc. Alternatively, the first accessibility indicator may be a cognitive limitation such as a attention and hyperactivity-impulsivity (e.g., ADHD), a memory/reasoning limitation (e.g., autism), a visual processing limitation (e.g., dyslexia), etc.

Each of these indicators may be linked to one or more accessibility features. For example, user interface generator 118 may utilize a data structure that lists each accessibility indicator and matches said indicator to the accessibility features needed for the user interface. For example, suppose that the first accessibility indicator is cortical vision impairment (CVI). The data structure may list the following accessibility features for CVI: (1) Dark mode (e.g., black background with neon foreground colors), (2) font size is larger than 12 pixels, (3) virtual object size is larger than 100 pixels, (4) minimum spacing between virtual objects is larger than 40 pixels, (5) use real images instead of abstract images (e.g., photo of an apple instead of a drawing), (6) audio enabled for all parts of activity module, (7) exaggerated movement (e.g., making hover or on-click state prominent). User interface generator 118 may thus generate user interface 126 in a first layout suitable for students with CVI (i.e., include all of these accessibility features).

In some aspects, each accessibility indicator may have a certain severity level. A severity level may be a quantitative value (e.g., an integer from 1 to 10) or a qualitative value (e.g., very low, low, medium, etc.) that indicates how severe an accessibility issue is. For example, level 1 CVI may have the recommended features listed above. Level 2 CVI may feature font sizes larger than 15 pixels, virtual object sizes larger than 200 pixels, etc.

Subsequent to generating user interface 126, user interface generator 118 may monitor an interaction of the user with the GUI when accessing an activity module. As mentioned before, this may involve collecting and processing clickstream data. For example, user interface generator 118 may detect a selection of an activity module at time t1, the selection of an answer choice at time t2, the selection of another answer choice at time t3, etc. These clicks are analyzed by user interface generator 118 to determine, for example, how long the user takes to answer a question in the activity module, whether the result ends up being a correct/incorrect response, whether the user revisits a question, etc.

In some aspects, the analyzed clickstream data with the data points described above are provided to an administrator (e.g., a teacher), that may manually adjust user interface 126 using manual settings 122. For example, the teacher can enlarge virtual objects in an activity module, change font size, increase spacing between virtual objects, turn on a screen reader, etc. A user (e.g., a student) may also be able to adjust certain settings as well. The changed settings are stored in accessibility indicators 116 as preferred settings.

In some aspects, user interface generator 118 may execute machine learning module 120, which includes multiple machine learning models. A first model may be trained to detect accessibility indicators based on activity scores (grades 112) and analyzed clickstream data from one or more of a plurality of activity modules. The first model may be trained using supervised learning in which the training dataset comprises a plurality of input vectors, each with analyzed clickstream data and/or grades. The vectors may each have a label of a particular accessibility indicator.

For example, user interface generator 118 may detect a second accessibility indicator based on the monitored interaction. The second accessibility indicator may be a different disorder unrelated to the first accessibility indicator (e.g., user interface generator 118 may detect an interaction that resembles the interaction that an autistic user has with the activity module). Alternatively, the second accessibility indicator may be a variation of the first accessibility indicator. For example, the first accessibility indicator may be a disability (e.g., CVI) at a first severity level (e.g., very low) and the second accessibility indicator may be the same disability at a second severity level (e.g., medium). In response to detecting the second accessibility indicator, user interface generator 118 may update the user profile of the user to include the second accessibility indicator.

User interface generator 118 may further automatically update user interface 126 to a second layout that is a variation of the first layout—the second layout being suitable for students with both the first accessibility indicator and the second accessibility indicator. For example, user interface generator 118 may alter one or more of the following of the first layout: (1) a type of virtual object depicted on the GUI (e.g., display a cartoon image instead of the real world image), (2) a size of a virtual object depicted on the GUI (e.g., increase the amount of space the object takes on the GUI relative to other objects), (3) a virtual distance between two or more virtual objects (e.g., increase the space between two answer choices), (4) a color of the virtual object (e.g., change the color of a shape from blue to red), and (5) a sound associated with selecting the virtual object (e.g., add a “ding” sound to the virtual object for playback upon selection). For example, user interface generator 118 may detect the second accessibility indicator, look up said indicator in the data structure that maps indicators to features, and implement the accessibility features needed for the second accessibility indictor in the second layout.

In some aspects, user interface generator 118 may incrementally change the first layout/second layout as more information is learned about the user. For example, the user may then start accessing another activity module. User interface generator 118 may thus monitor another interaction of the user with the GUI when accessing another activity module. In response to detecting a third accessibility indicator based on the another interaction, user interface generator 118 may update user interface 126 to a third layout that is a variation of the second layout—the third layout being suitable for students with the first accessibility indicator, the second accessibility indicator, and the third accessibility indicator.

Likewise, it is possible that as a user develops with age, therapy, medication, etc., their need for certain accessibility features may decrease. For example, user interface generator 118 may monitor another interaction of the user with the GUI when accessing another activity module. In response to determining that the another interaction does not comprise the second accessibility indicator, user interface generator 118 may revert the GUI to the first layout.

In some aspects, machine learning module 120 includes a second machine learning model that automatically applies updates to an existing layout. For example, the second machine learning model may utilize reinforcement learning to optimize user interface 126 for the user such that an amount of time to complete an activity module is minimized and an amount of correct responses received from the user in the activity module is maximized. In some aspects, there may certain preset milestones/targets to hit in terms of time to complete the activity module and the amount of correct responses. In other words, the second model seeks to minimize the time to a target time and maximize the amount of correct responses to a target response count. If a user is having a hard time interacting with the GUI, one of the signs expected is extended amounts of time spent per portion of the activity module (e.g., more time spent answering a question than an average user spends answering said question). Another sign is a several incorrect responses. Although these signs may simply be present when a user does not fully comprehend the information tested by the activity module, if an incremental change leads to improved performance by the user (i.e., less time to reach the correct response), then user interface generator 118 may attribute the poor initial performance to difficulties interacting with the user interface itself.

Reinforcement learning is applied in scenarios where the optimal decision-making strategy is learned through trial and error, without explicit guidance. It finds applications in various domains, including robotics, game playing, and autonomous systems. More specifically, reinforcement learning involves an agent learning to make decisions by interacting with an environment. The agent receives feedback in the form of rewards or penalties based on its actions, allowing it to learn optimal strategies through trial and error. The primary components of reinforcement learning are as follows: agent, environment, state, action, reward, exploration and exploitation, learning policy, and value function. An agent (e.g., the learner of the system) is the entity that takes actions in the environment. The environment is the external system with which the agent interacts. The environment provides feedback to the agent based on the actions taken. The state is a representation of the current situation or configuration of the environment. Actions are the moves or decisions that the agent can take within the environment. A reward is a numerical signal that indicates the immediate benefit or cost of an action taken by the agent. The agent's objective is to maximize the cumulative reward over time. The reinforcement learning process typically involves the following steps. The agent explores the environment to discover the most rewarding actions (exploration) and exploits a current knowledge to take actions the agent believes will yield the highest cumulative reward (exploitation). The agent learns a policy, which is a strategy that maps states to actions, based on the observed rewards and its exploration-exploitation trade-offs. The agent may also learn a value function, estimating the expected cumulative reward from a given state or state-action pair.

For example, the agent of the second machine learning model may analyze the performance of a student on a portion-by-portion manner within one activity module or on a module-by-module manner across multiple activity modules.

In the former case, the model analyzes clickstream data within a first portion of the activity module and performs an action based on known or newly detected accessibility indicators and grades data. For example, the action may involve increasing the contrast of the graphics used in the activity module. The effects of this action are analyzed during a second portion of the activity module. Suppose that the performance of the user improves (e.g., the user answers a question in the first portion correctly under a threshold period of time); this action results in a reward. The model may then implement a second action based on the clickstream data collected from the second portion. The second action may involve replacing spelled-out numbers (e.g., “FOUR”) with a numerical representation (e.g., “4”). The effects of the second action are then analyzed and further actions are taken to yield the highest cumulative reward (e.g., a student performance greater than a threshold student performance).

The latter case is similar to the former case except that the performance and clickstream data is analyzed over one or more activity modules. In other words, the performance of the user is assessed in a first activity module, an action is taken by the second machine learning model accordingly (e.g., replacing numbers with abstract representations such as showing four apples in place of the number “4”) when the user accesses a second activity module, and the performance is assessed again.

The trial and error approach to updating user interface 126 may take several iterations. Certain actions may cause lower performance and are thus reverted. Certain actions may increase performance and are thus promoted. When a threshold number of actions do not increase/decrease performance by a threshold amount (e.g., ten consecutive actions do not increase/decrease a cumulative completion speed by at least X seconds or increase/decrease an average amount of correct responses by Y responses), user interface generator 118 may halt the use of the model. In this case, it may be presumed that the ideal layout for the user has been achieved. The layout of the user interface 126 may thus be reverted to a state before implementing the unnecessary actions.

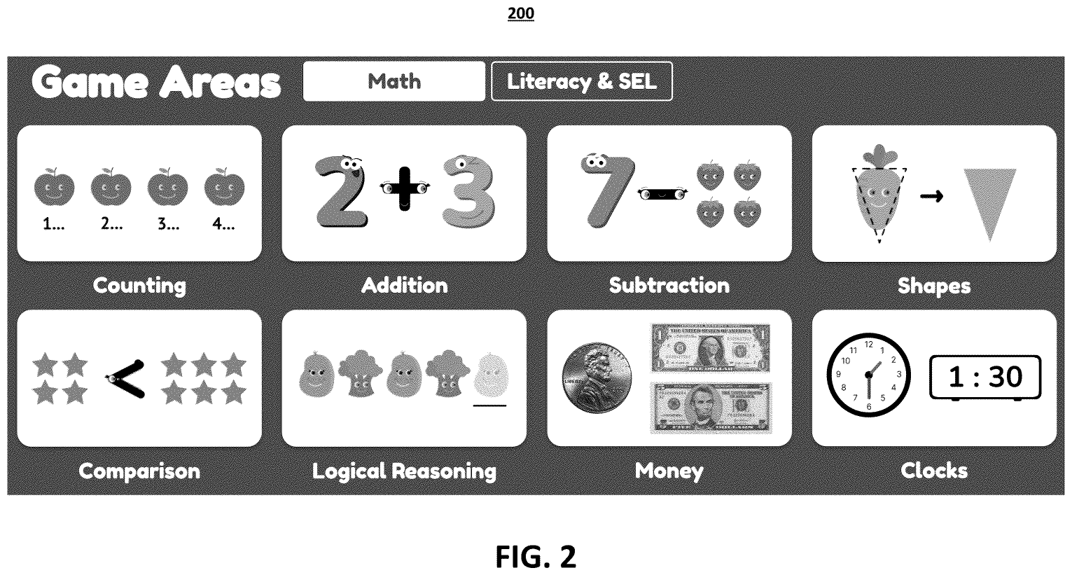

FIG. 2 is a first view 200 of the user interface of the educational platform. In view 200, user interface 126 depicts various types of activity modules that the user can select from. These types of activity modules include, but are not limited to, counting, addition, subtraction, shapes, comparison, logical reasoning, money, and clocks.

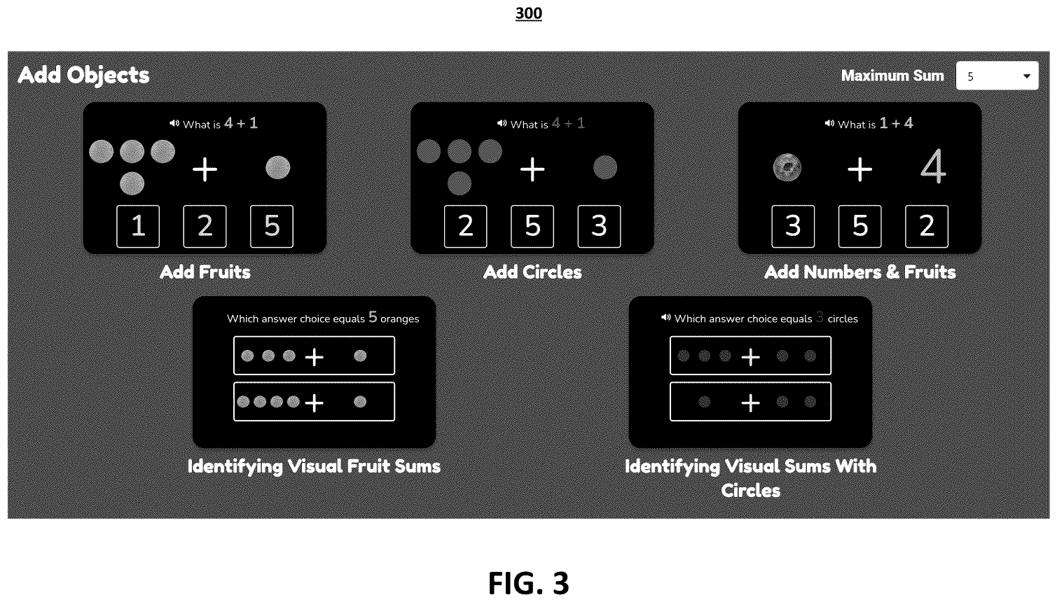

FIG. 3 is a second view 300 of the user interface of the educational platform. Suppose that the user selects the virtual object (e.g., button) associated with “addition” in view 200. In view 300, user interface 126 depicts a plurality of activity modules associated with the selected activity module type. For example, view 300 shows an activity module in which fruit counts are to be added and another activity module in which visual sums are to be identified using circles.

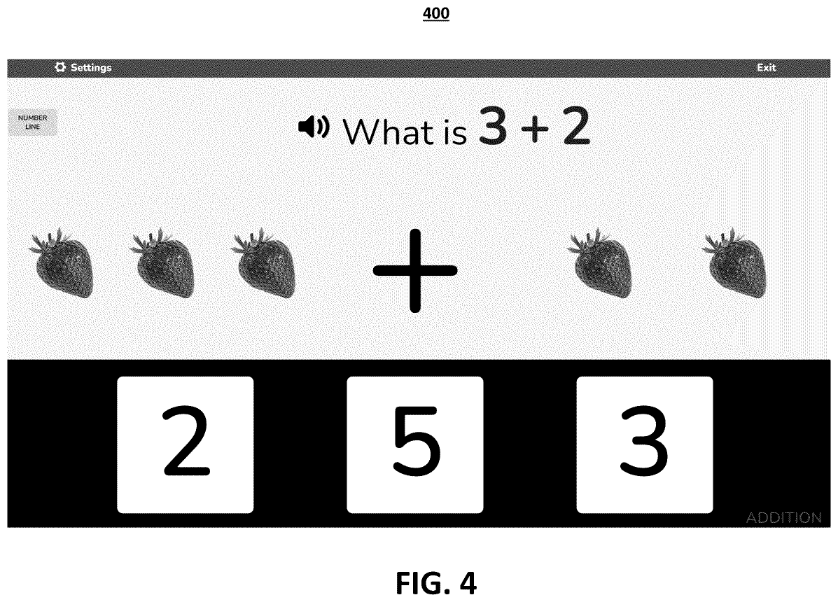

FIG. 4 is a third view 400 of the user interface of the educational platform. Suppose that the user selects the virtual object associated with adding fruits in view 300. In view 400, a portion (e.g., a question) is shown from the selected activity module. For example, view 400 displays a question “what is 3+2?” and visual representation of the question where three strawberries are being added to two strawberries. The question is accompanied by three answer choices: 2, 5, and 3. The user may also click on the sound icon next to the textual representation of the question to get a read aloud of the contents of the screen (e.g., recite any combination of the question, the depiction of the strawberries, the answer choices, their relative placement, etc.). In some aspects, depending on the accessibility indicator of the user, the read aloud option is automatically executed when view 400 is generated (e.g., if the user has a visual impairment and needs audio accompaniment).

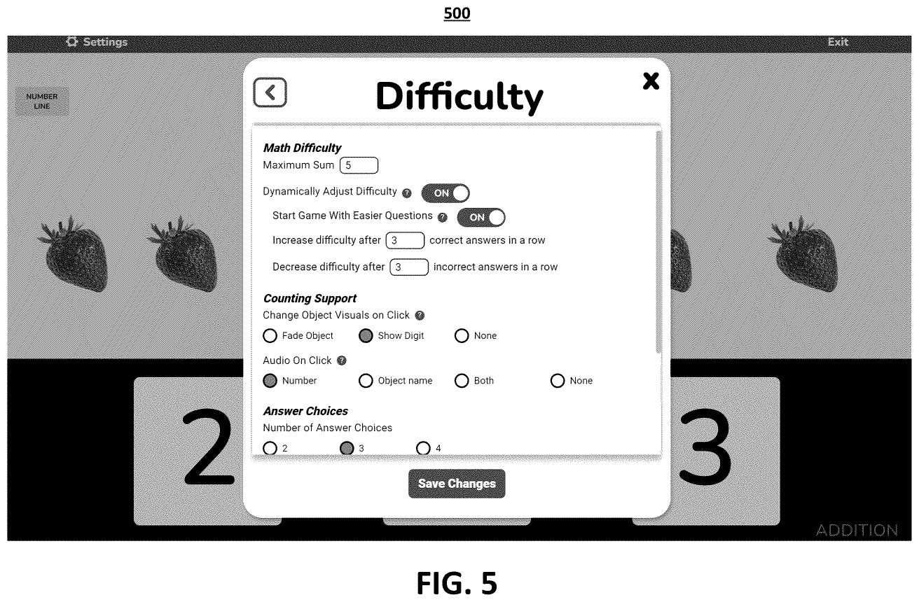

FIG. 5 is a fourth view 500 of the user interface of the educational platform. In view 400, a user may select the virtual object for “settings.” This may generate a pop-up window as shown in view 500. The user can then customize the content of the activity module (e.g., difficulty of questions) or the presentation of the activity module (e.g., which virtual objects to show or hide).

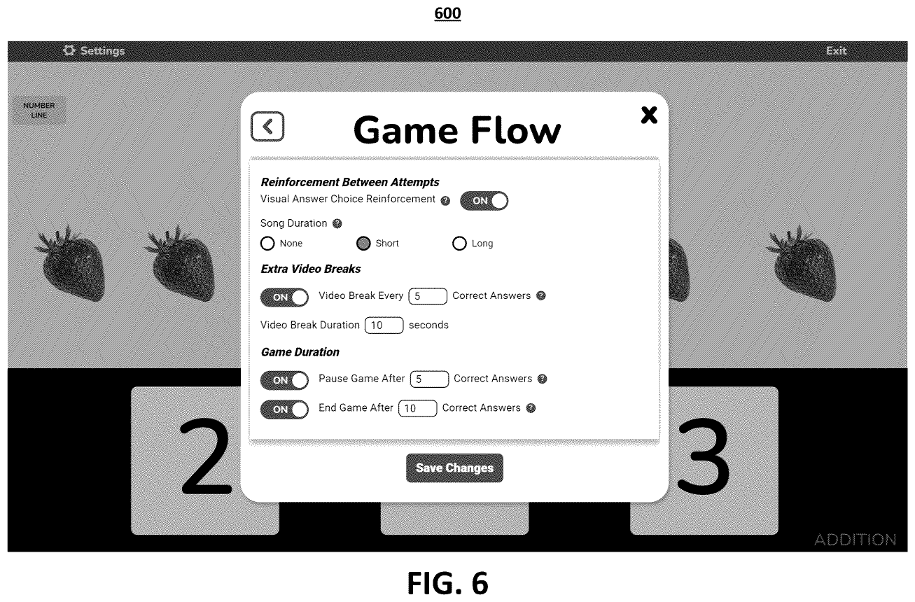

FIG. 6 is a fifth view 600 of the user interface of the educational platform. In view 600, additional customizable options for the activity module are shown. For example, the user may set a game duration and when video breaks occur between portions of the activity module.

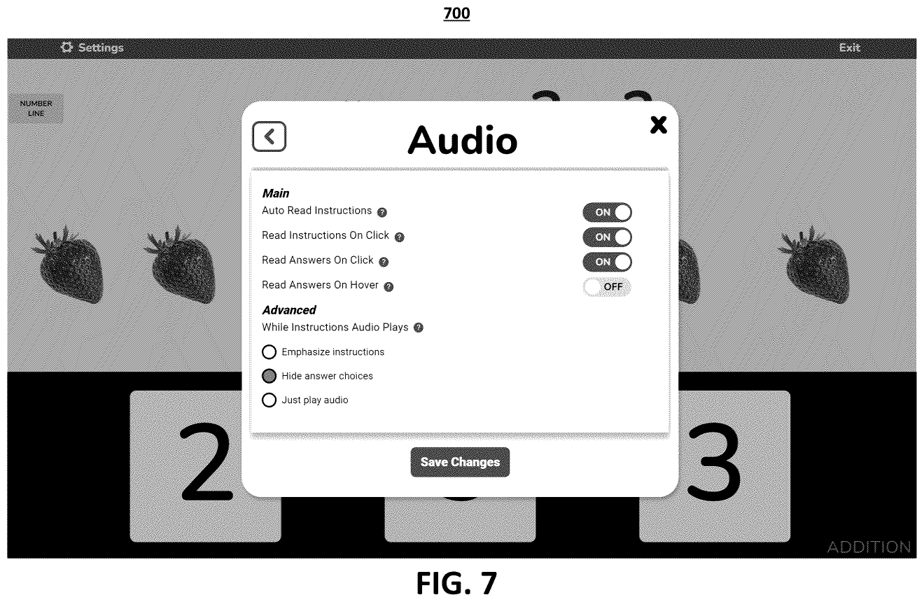

FIG. 7 is a sixth view 700 of the user interface of the educational platform. In view 700, audio-based options for the activity module are shown. For example, the user can activate an accessibility feature in which the instructions of an activity module are automatically read aloud.

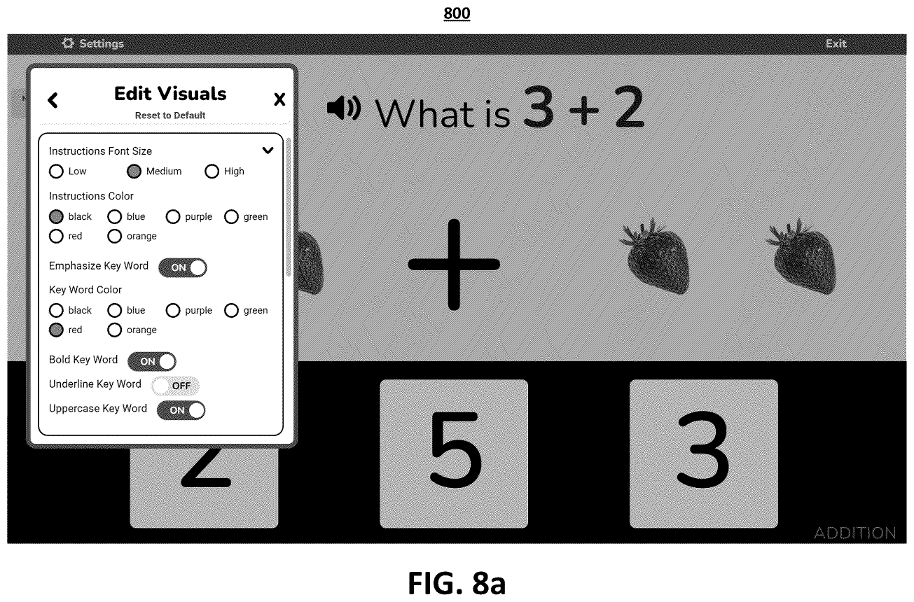

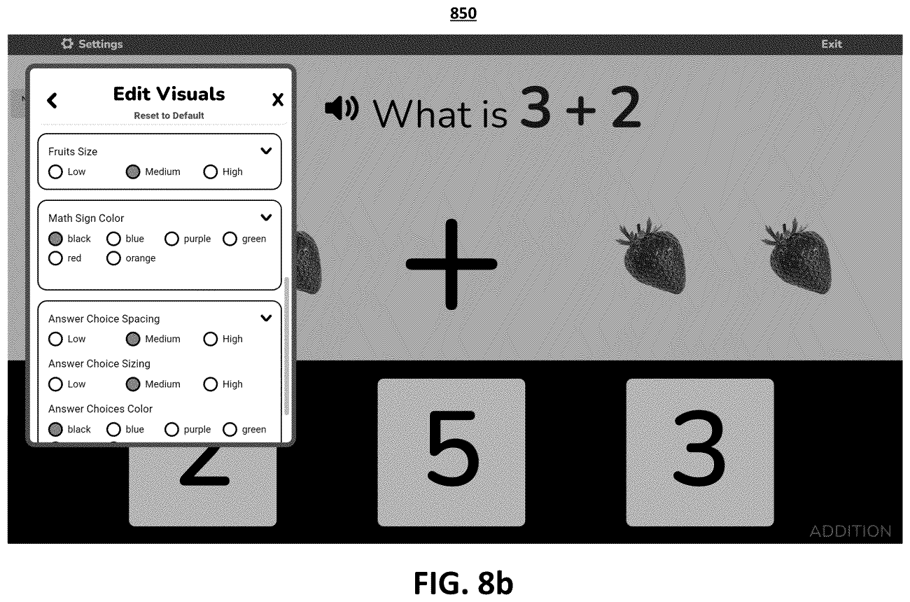

FIG. 8a is a seventh view 800 of the user interface of the educational platform. In view 800, visual-based options for the activity module are shown. For example, the user can activate an accessibility feature in which the font size is changed is from “low” to “high.” Similarly, the user can select another accessibility feature in which the colors of various texts are changed (e.g., instructions text color changed from black to blue).

FIG. 8b is a eighth view 850 of the user interface of the educational platform. In view 850, additional visual-based options for the activity module are shown. For example, the user can increase the size of the answer choices or adjust the spacing between answer choices.

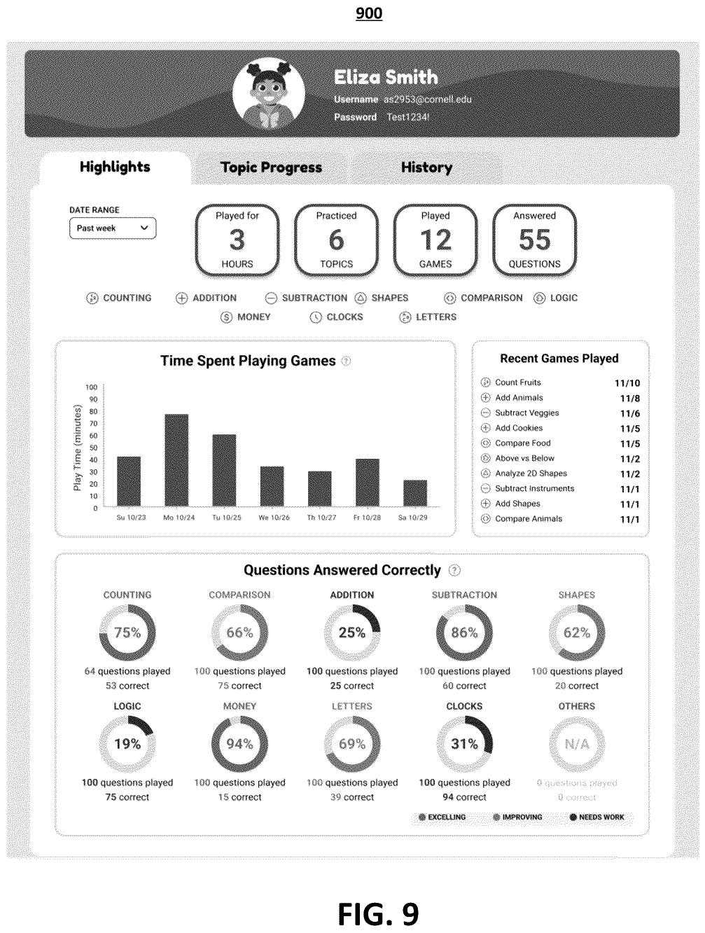

FIG. 9 is a ninth view 900 of the user interface of the educational platform. In view 900, the user or an administrator may view the grades and statistics of the user. For example, view 900 depicts the number of questions answered in each activity module type, the amount of questions that had correct responses, the amount of time spent interacting with activity modules on a daily basis, etc. This data may be used to adjust the activity modules (e.g., change difficulties) or adjust accessibility features (e.g., to boost scores).

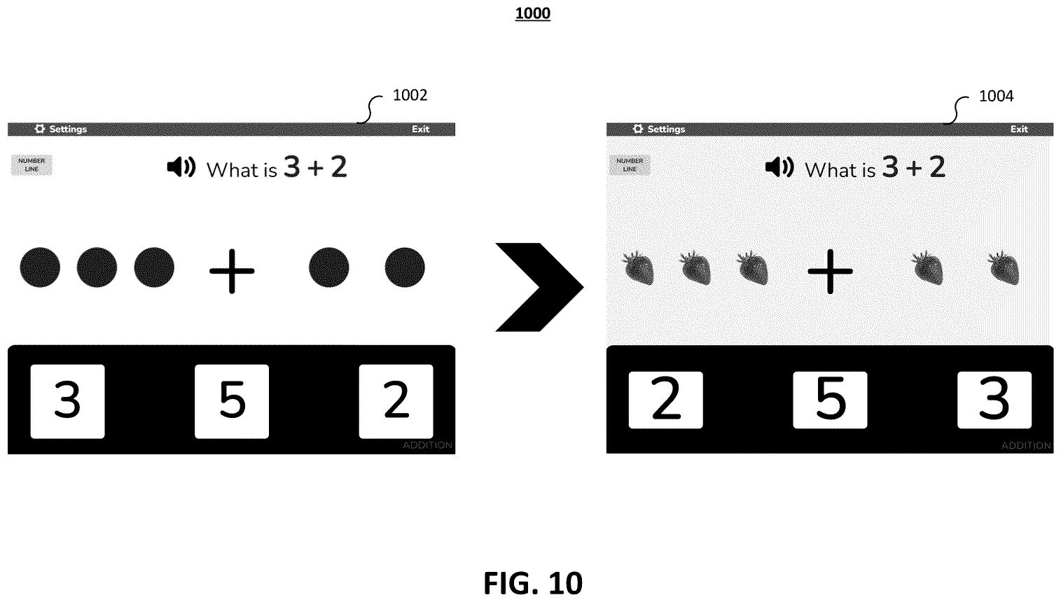

FIG. 10 is a diagram 1000 of layout updates in the user interface of the educational platform. Diagram 1000 depicts an automatic update of user interface 126. Suppose that user interface 126 initially appears as layout 1002, in which circles are used as a visual representation. Based on the analyzed clickstream data of the user and grades, user interface generator 118 may detect “CVI” as an accessibility indicator. User interface generator 118 may then make an incremental change where the circles (e.g., an abstract image) is replaced with strawberries (e.g., real-world images). This is shown in layout 1004. In some aspects, user interface generator 118 implements layout 1004 when the user starts a new activity module or enters a new portion of the activity module (e.g., the next question).

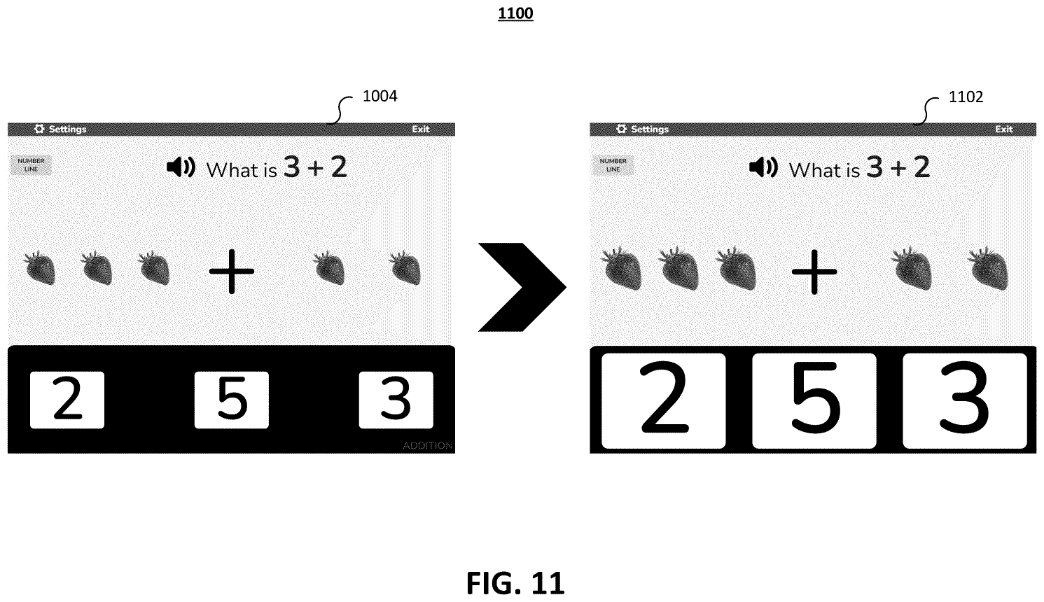

FIG. 11 is a diagram 1100 of layout updates in the user interface of the educational platform. Suppose that at a later time, user interface generator 118 determines that the user has a more severe form of CVI. Accordingly, user interface generator 118 may make another update on layout 1004. As shown in diagram 1100, the size of strawberries and the answer choices is increased in layout 1102. This makes those objects more prominent and easier to select by the user.

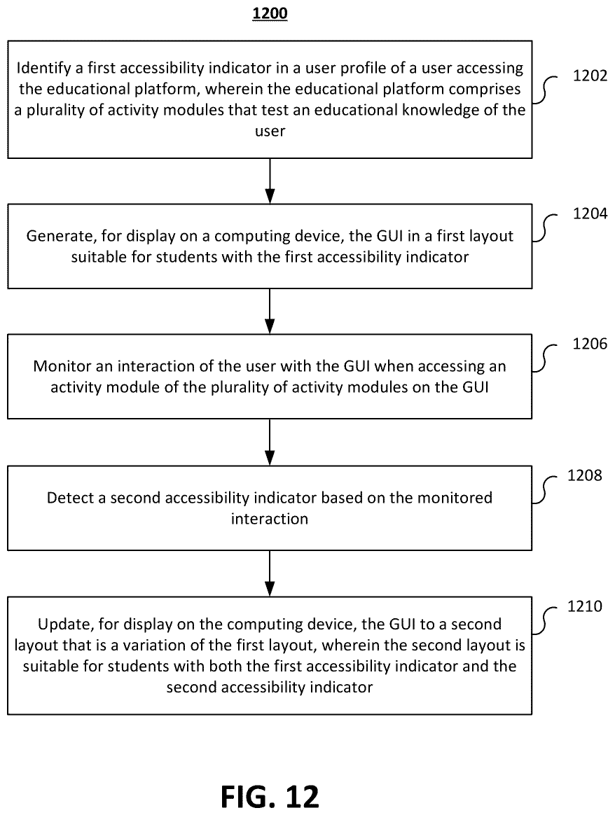

FIG. 12 illustrates a flow diagram of a method 1200 for incrementally updating a graphical user interface of an educational platform to accommodate accessibility issues of a user.

At 1202, user interface generator 118 identifies a first accessibility indicator (e.g., CVI level 1) in a user profile of a user accessing educational platform 102, which includes plurality of activity modules 104 that test an educational knowledge of the user.

At 1204, user interface generator 118 generates, for display on a computing device (e.g., computing device 101a), the GUI (e.g., user interface 126) in a first layout suitable for students with the first accessibility indicator.

At 1206, user interface generator 118 monitors an interaction of the user with the GUI when accessing an activity module of the plurality of activity modules on the GUI.

At 1208, user interface generator 118 detects a second accessibility indicator based on the monitored interaction.

At 1210, user interface generator 118 updates, for display on the computing device, the GUI to a second layout that is a variation of the first layout, wherein the second layout is suitable for students with both the first accessibility indicator and the second accessibility indicator.

FIG. 13 is a block diagram illustrating a computer system 20 on which aspects of systems and methods for incrementally updating a graphical user interface of an educational platform to accommodate accessibility issues of a user may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-12 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for updating a graphical user interface (GUI) of an educational platform, the method comprising:
identifying a first accessibility indicator in a user profile of a user accessing the educational platform, wherein the educational platform comprises a plurality of activity modules that test an educational knowledge of the user;
generating, for display on a computing device, the GUI in a first layout suitable for students with the first accessibility indicator;
monitoring an interaction of the user with the GUI when accessing an activity module of the plurality of activity modules on the GUI; and
in response to detecting a second accessibility indicator based on the monitored interaction, updating, for display on the computing device, the GUI to a second layout that is a variation of the first layout, wherein the second layout is suitable for students with both the first accessibility indicator and the second accessibility indicator.

2. The method of claim 1, further comprising:
monitoring another interaction of the user with the GUI when accessing another activity module of the plurality of activity modules on the GUI; and
in response to detecting a third accessibility indicator based on the another interaction, updating, for display on the computing device, the GUI to a third layout that is a variation of the second layout, wherein the third layout is suitable for students with the first accessibility indicator, the second accessibility indicator, and the third accessibility indicator.

3. The method of claim 1, further comprising:
monitoring another interaction of the user with the GUI when accessing another activity module of the plurality of activity modules on the GUI; and
in response to determining that the another interaction does not comprise the second accessibility indicator, reverting the GUI to the first layout.

4. The method of claim 1, wherein monitoring the interaction comprises determining one or more of:
(1) an amount of time taken to fully complete the activity module,
(2) an amount of time taken to complete a portion of the activity module,
(3) a number of times the activity module is closed or restarted,
(4) a number of times a portion of the activity module is restarted,
(5) a number of correct responses received from the user in the activity module,
(6) a number of incorrect responses received from the user in the activity module, and
(7) a number of manual setting adjustments made during the activity module.

5. The method of claim 1, wherein detecting the second accessibility indicator based on the monitored interaction comprises executing a machine learning algorithm trained to detect accessibility indicators based on activity scores and clickstream data and from one or more of the plurality of activity modules.

6. The method of claim 1, wherein updating the GUI to the second layout comprises executing a machine learning algorithm that utilizes reinforcement learning to optimize the GUI for the user such that an amount of time to complete the activity module is minimized and an amount of correct responses received from the user in the activity module is maximized.

7. The method of claim 1, wherein the first accessibility indicator is a disability at a first severity level and the second accessibility indicator is the disability at a second severity level.

8. The method of claim 1, wherein the GUI comprises a plurality of virtual objects, and wherein updating the GUI to the second layout comprises incrementally altering one or more of:
(1) a type of virtual object depicted on the GUI,
(2) a size of a virtual object depicted on the GUI,
(3) a virtual distance between two or more virtual objects,
(4) a color of the virtual object, and
(5) a sound associated with selecting the virtual object.

9. The method of claim 1, wherein the first accessibility indicator comprises one of a behavioral disability, vision impairment, a hearing impairment, a cognitive impairment, a mental disorder, motor impairment.

10. The method of claim 1, wherein the user profile is indicative of one or more of: an age, a gender, a school grade level, scores on any of the plurality of activity modules, and any known accessibility issues.

11. A system for updating a graphical user interface (GUI) of an educational platform, comprising:
at least one memory;
at least one hardware processor coupled with the at least one memory and configured, individually or in combination, to:
identify a first accessibility indicator in a user profile of a user accessing the educational platform, wherein the educational platform comprises a plurality of activity modules that test an educational knowledge of the user;
generate, for display on a computing device, the GUI in a first layout suitable for students with the first accessibility indicator;
monitor an interaction of the user with the GUI when accessing an activity module of the plurality of activity modules on the GUI; and
in response to detecting a second accessibility indicator based on the monitored interaction, update, for display on the computing device, the GUI to a second layout that is a variation of the first layout, wherein the second layout is suitable for students with both the first accessibility indicator and the second accessibility indicator.

12. The system of claim 11, wherein the at least one hardware processor is further configured to:
monitor another interaction of the user with the GUI when accessing another activity module of the plurality of activity modules on the GUI; and
in response to detecting a third accessibility indicator based on the another interaction, update, for display on the computing device, the GUI to a third layout that is a variation of the second layout, wherein the third layout is suitable for students with the first accessibility indicator, the second accessibility indicator, and the third accessibility indicator.

13. The system of claim 11, wherein the at least one hardware processor is further configured to:
monitor another interaction of the user with the GUI when accessing another activity module of the plurality of activity modules on the GUI; and
in response to determining that the another interaction does not comprise the second accessibility indicator, revert the GUI to the first layout.

14. The system of claim 11, wherein the at least one hardware processor is further configured to monitor the interaction by determining one or more of:
(1) an amount of time taken to fully complete the activity module,
(2) an amount of time taken to complete a portion of the activity module,
(3) a number of times the activity module is closed or restarted,
(4) a number of times a portion of the activity module is restarted,
(5) a number of correct responses received from the user in the activity module,
(6) a number of incorrect responses received from the user in the activity module, and
(7) a number of manual setting adjustments made during the activity module.

15. The system of claim 11, wherein the at least one hardware processor is further configured to detect the second accessibility indicator based on the monitored interaction by executing a machine learning algorithm trained to detect accessibility indicators based on activity scores and clickstream data and from one or more of the plurality of activity modules.

16. The system of claim 11, wherein the at least one hardware processor is further configured to update the GUI to the second layout by executing a machine learning algorithm that utilizes reinforcement learning to optimize the GUI for the user such that an amount of time to complete the activity module is minimized and an amount of correct responses received from the user in the activity module is maximized.

17. The system of claim 11, wherein the first accessibility indicator is a disability at a first severity level and the second accessibility indicator is the disability at a second severity level.

18. The system of claim 11, wherein the GUI comprises a plurality of virtual objects, and wherein the at least one hardware processor is further configured to update the GUI to the second layout by incrementally altering one or more of:
(1) a type of virtual object depicted on the GUI,
(2) a size of a virtual object depicted on the GUI,
(3) a virtual distance between two or more virtual objects,
(4) a color of the virtual object, and
(5) a sound associated with selecting the virtual object.

19. The system of claim 11, wherein the first accessibility indicator comprises one of a sight-based disorder, a hearing disorder, a speaking disorder, a mental disorder, a physical disability.

20. A non-transitory computer readable medium storing thereon computer executable instructions for updating a graphical user interface (GUI) of an educational platform, including instructions for:
identifying a first accessibility indicator in a user profile of a user accessing the educational platform, wherein the educational platform comprises a plurality of activity modules that test an educational knowledge of the user;
generating, for display on a computing device, the GUI in a first layout suitable for students with the first accessibility indicator;
monitoring an interaction of the user with the GUI when accessing an activity module of the plurality of activity modules on the GUI; and
in response to detecting a second accessibility indicator based on the monitored interaction, updating, for display on the computing device, the GUI to a second layout that is a variation of the first layout, wherein the second layout is suitable for students with both the first accessibility indicator and the second accessibility indicator.
